(19) United States
(12) Patent Application Publication
(10) Pub. No.: US 2005/0260386 A1
(43) Pub. Date: Nov. 24, 2005

(54) Partially structured multilayered film whose form can be decorated

(76) Inventors: Matthias Heinrich, Wurzburg (DE); Andreas Hirschfelder, Furth (DE)

Correspondence Address: Charles R Hoffmann;Hoffmann & Baron, 6900 Jericho Turnpike, Syosset, NY, 11791-4407, US

(21) Appl. No.: 10/524,236

(22) PCT Filed: Aug. 8, 2003
(86) PCT No.: PCT/DE03/02683

§ 371 Date: Feb. 10, 2005

(30) Foreign Application Priority Data
Aug. 10, 2002 (DE) 10236810.4

(51) Int. Cl. B32B 1/00

(52) U.S. Cl. 428/141; 428/174

(57) ABSTRACT

The invention concerns a decorated article, in particular a mobile telephone housing or a mobile telephone window, and a multi-layer film, in particular an IMD-able stamping film. The decorated article has a base body and at least one decorative element arranged on the surface of the base body. The decorative element has a transparent structure layer which has a spatial structure producing an optically perceptible effect, and a reflection layer arranged between the surface of the base body and the structure layer.

The invention concerns a decorated article, in particular a mobile telephone housing or a mobile telephone window, which has a base body and a decorative element arranged on the surface of the base body. The invention further concerns a multi-layer film for the production of decorated articles.

An in-mold process with which it is possible to produce plastic articles decorated by means of a film is disclosed in WO 93/04837.

A film is arranged between two mold halves of an injection molding mold. The two mold halves are moved towards each other, forming a mold cavity. In that situation the film is clamped fast between the two mold halves. Thereupon, a plastic material is injected into the mold cavity through at least one sprue runner provided in the mold. The plastic sprue which is defined by the sprue runner and which is joined to the plastic article is cut off the plastic article before the plastic material hardens in the mold. After the sprue which has not yet hardened is cut off the plastic article which has not yet hardened, the plastic material hardens in the mold in the closed condition. Thereupon the mold is opened and the hardened plastic article in the finished decorated form is removed from the mold cavity and the sprue which has hardened separately therefrom is removed from the sprue runner.

In the operation of injecting the plastic material the film is pressed against a surface region of the mold cavity by the hot plastic material. As a result the stamping film adopts the surface configuration of the mold cavity and is joined to the plastic material which forms the base body of the decorated plastic article.

A further in-mold process is known from EP 0 412 493 A2.

That process provides that a card, for example an identity card, a credit card or a timekeeping card is produced using a film. The film has a decorative layer arrangement with two decorative layers and between them an opaque intermediate layer. A crystal-clear material is used as the injection molding material. The film is arranged in a cavity of an injection molding mold, the cavity corresponding in volume to the card. The cavity of the mold is then closed and filled with the injection molding material.

DE 26 49 479 A1 describes a hot stamping film of the following structure:

The hot stamping film comprises a carrier film, a cover lacquer layer and an adhesive layer. Arranged on the surface of the cover lacquer layer, which is opposite to the carrier film, are a metal layer and a bonding agent layer portion. An adhesive layer is applied to the bonding agent layer portion. The cover lacquer layer is transparent and is provided with a spatial patterning on its surface which is opposite to the carrier film.

The object of the invention is further to improve the decoration of articles by means of a multi-layer film.

That object is attained by a decorated article, a mobile telephone housing or a mobile telephone window, which has a base body which has curved surface regions and at least one decorative element arranged in the region of one or more curvatures of the surface of the base body, wherein the decorative element is formed by an IMD-film or a deep-drawable film which is deformed in production of the base body in accordance with the one or more curvatures and the IMD-film or deep-drawable film has a transparent structure layer having a spatial structure producing an optically perceptible effect, and has a reflection layer arranged between the surface of the base body and the structure layer. The object of the invention is further attained by a multi-layer film for the production of decorated articles having curved surface regions, which is an IMD-film or a deep-drawable film which is deformed in production of the decorated article in accordance with the curvature of the base body of the decorated article, wherein the IMD-film or deep-drawable film has a transparent structure layer which has a spatial surface structure producing an optically perceptible effect, and a reflection layer arranged beneath the structure layer in the viewing direction.

The invention affords the advantage that the number of available decorative elements is increased and thus the range of shapes available for a designer is enlarged.

In that respect particular advantages are achieved if the optical effect produced by the spatial structure is extinguished in regions in which the base body is curved.

IMD-films (IMD=in-mold) and deep-drawable films are subjected to high temperatures and high mechanical forces in the decoration of articles. In particular the mechanical deformation effects which occur in the decoration process have the result that decoration with a spatial structure producing an optically perceptible effect often leads to unsatisfactory results. Distortion of the IMD-film or deep-drawable film also causes the structure layer to be distorted and thus also changes the spatial structures applied to the structure layer. Those distortion effects are particularly severe in regions in which the base body has one or more curvatures. Tests and investigations have shown that particularly severe changes in the spatial structure of the structure layer occur in those regions. Under some circumstances those changes in spatial structure severely falsify the optical effect which is produced by the spatial structure so that this gives an unsightly overall optical result.

That effect however does not occur in the case of the “extinguishing step” performed in accordance with the invention.

In that respect the optical effect of the spatial structure in curvature regions is preferably extinguished by a procedure whereby the optical effect of the spatial structure is extinguished in a pattern configuration by means of an intermediate layer which is shaped in pattern form and which is arranged between the structure layer and the reflection layer and/or by means of removal in a pattern configuration, in particular demetalization, of the reflection layer in regions in which the curvature of the surface structure exceeds a limit value.

That affords major advantages over other possible methods, for example a base body-specific configuration of the surface structure:

Thus, the stamping tools used for the production of 3-D pattern portions can be used in a more versatile manner. The spatial structure can be altered and individualized in many different ways by virtue of the patterned extinguishing of the optically perceptible effect in partial regions of the spatial structure. That makes it possible to produce a large number of different decorations, by means of a stamping tool. That affords considerable cost savings.

By virtue of partially extinguishing the structure layer it is possible further to produce additional decorative elements which significantly improve the use of an IMD-process (IMD=in-mold) or a decorated article provided with a deep-drawable film. The optical effect of the spatial structure can be extinguished for example in regions in which the curvature of the structure exceeds a limit value. Negative effects of an excessively high radius of curvature on the optical appearance of the decoration can be prevented in that way, whereby the optical appearance of the decorated article is improved.

If a structure layer comprising flexurally stable plastic material is used, it is advantageous to use as the limit value the radius of curvature at which changes in the optical effect of the spatial structure, which are visible to a viewer, occur due to bending of the structure layer.

When using a plastic material which is not flexurally stable for the structure layer it has further been found to be advantageous to select as the limit value the radius of curvature of the structure layer, at which breaks occur in the structure layer.

In accordance with a further preferred embodiment of the invention the structure layer has desired-fracture locations so that the structure layer breaks up in a defined fashion in regions in which the base body has one or more curvatures and thus the structure layer is also correspondingly curved. Here too it is appropriate for the desired-fracture locations to be provided in such a way that the structure layer breaks up into predefined fracture portions as from a predefined radius of curvature. In that case the desired-fracture locations are preferably arranged in such a way that the optical effect produced by the structure is not adversely affected by the structure layer breaking up in the region of the desired-fracture locations. Accordingly the optical effect produced by the structure layer is not extinguished in the region of the curvature but is maintained.

In addition it is also possible for the desired-fracture locations to be arranged in such a way that the optical effect is no longer produced in regions in which the structure layer is broken up.

In accordance with a further preferred embodiment of the invention the reflection layer has desired-fracture locations so that the reflection layer breaks up in a defined manner in regions in which the curvature of the base body and thus also the curvature of the reflection layer exceeds a given limit value, wherein the optical effect produced by the structure is optically no longer visible in that region and is thus extinguished.

In accordance with a further preferred embodiment of the invention arranged between the structure layer and the reflection layer is a further layer having a higher refractive index than the structure layer. That additional layer enhances the optical impression of depth, which greatly improves the optical effect of the three-dimensional decorated article. It is particularly advantageous here if that further layer comprises a material which has thermally insulating properties. Those thermally insulating properties improve processing of the IMD-film or deep-drawable film as the thermal influence on the structure layer is reduced in processing of the IMD-film or deep-drawable film. The thermal processing window is increased and damage to the spatial structure, which leads to falsification of the optical effect produced by the spatial structure, is avoided.

Particular advantages are also afforded here if in this case the reflection layer is removed in a window-shaped region so that a semitransparent and/or transparent window is formed in that region. In that respect, that semitransparent window can be provided in particular in those regions in which an optical display device, for example an LCD display (LCD=liquid crystal display) is provided beneath that window.

An embodiment of the invention which is particularly inexpensive and simple to implement provides for using an intermediate layer comprising one or more extinguishing lacquer layers, wherein the extinguishing lacquer layer comprises a transparent material and levels the structure of the structure layer in a pattern configuration. That leveling of the structure means that the structure is optically extinguished in a pattern configuration. A further option involves producing the extinguishing lacquer layers from an opaque material. The extinguishing lacquer layers can be applied by means of a printing process so that production is particularly inexpensive.

It is advantageous for the intermediate layer to be formed from a flexible thermoplastic material. In that way the intermediate layer can particularly easily adapt to a curved base body. Further advantages are achieved by the flexibility of the intermediate layer being different from that of the structure layer. The intermediate layer is thus maintained even when small bending radii are involved, which result in fracture of the structure layer, and the intermediate layer can thus perform its function precisely in the critical regions in which the use of an intermediate layer is particularly advantageous.

Decorative advantages are afforded by coloring the intermediate layer and/or the structure layer, by coloring a protective lacquer layer and by using one or more decorative color layers in the structure of the multi-layer film.

Particularly good results are achieved if the structure layer comprises a suitable thermoplastic material into which the spatial structures are embossed. That configuration of the structure layer means that it can adapt particularly easily to the surface of curved base bodies. The use of a suitable thermoplastic material also gives the advantage that the embossed spatial structures are not distorted and thus the optically perceptible effect produced by the spatial structure is not falsified when the structure layer is bent. This means that the overall result which is perceptible to a viewer is significantly improved when decorating curved surface regions, in particular when using an in-mold process.

Optical effects which are of particular attraction for the decoration of articles can be achieved by the use of structures involving a structure, which does not have an optical-diffraction effect, of a roughness depth of the order of magnitude of between 0.8 and 10 μm. Structures of that kind are also particularly less susceptible to the above-described adverse optical effects caused by the curved base body.

It may however also be desirable for the structure to be provided with a diffractive structure having an optical-diffraction effect. It is possible in that way to produce decorative effects such as holograms and the like.

A particularly scratch-resistant surface is achieved if the multi-layer film has a protective lacquer layer arranged above the structure layer in the viewing direction and the spatial structure is applied to the structure layer towards the reflection layer.

It is desirable here if the protective lacquer layer of the multi-layer film is colored. Further advantages can be achieved if the multi-layer film has a protective lacquer layer arranged above the structure layer and also has one or more decorative color layers arranged between the protective lacquer layer and the reflection layer.

It is further advantageous to use a laminating film or an overstamping film with a structure layer in accordance with the invention for the IMD-region.

The invention is described by way of example hereinafter by means of a number of embodiments by way of example with reference to the accompanying drawings in which:

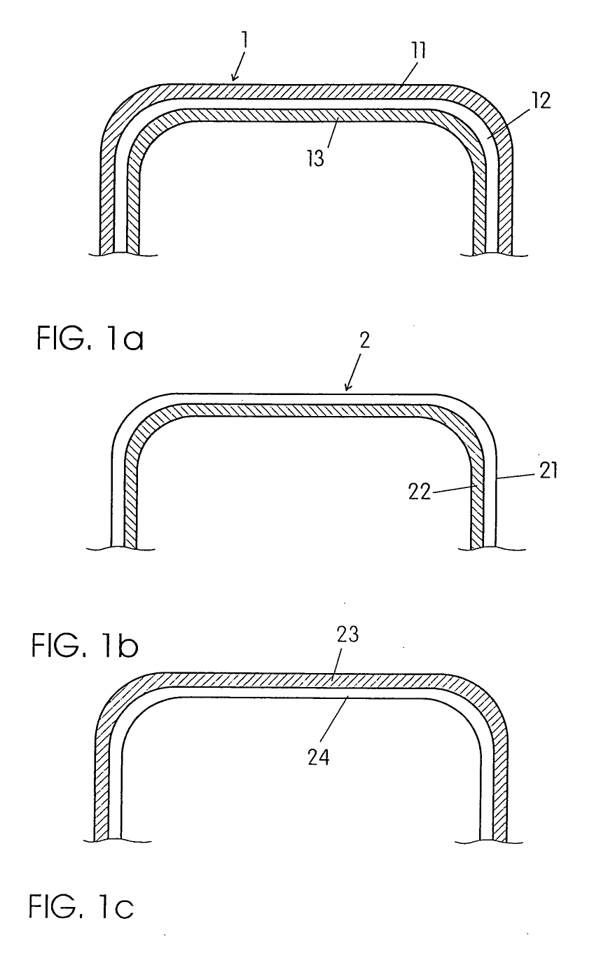

FIG. 1a shows a sectional view of an article decorated in accordance with the invention for a first embodiment,

FIG. 1b shows a sectional view of an article decorated in accordance with the invention for a second embodiment,

FIG. 1c shows a sectional view of an article decorated in accordance with the invention for a third embodiment,

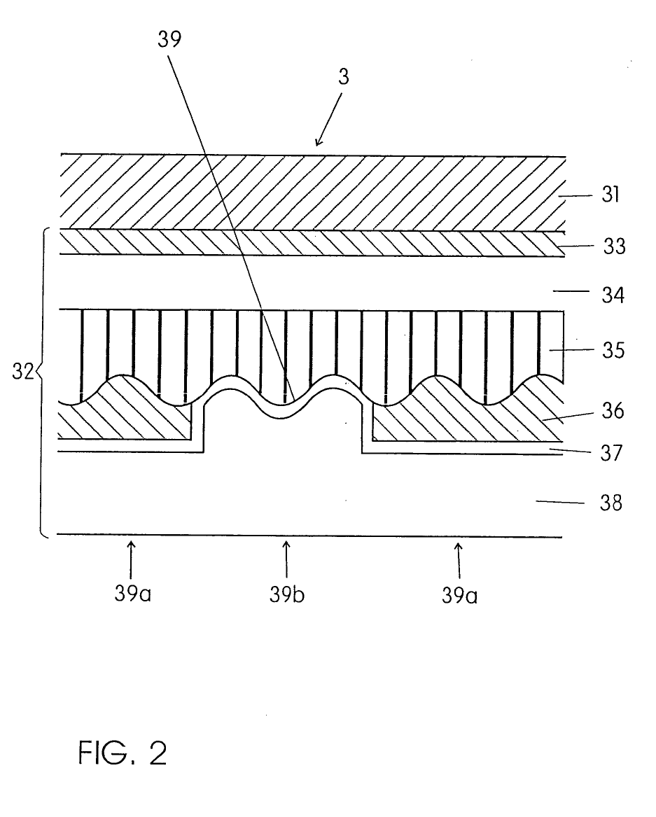

FIG. 2 shows a sectional view of a first embodiment of a multi-layer film according to the invention,

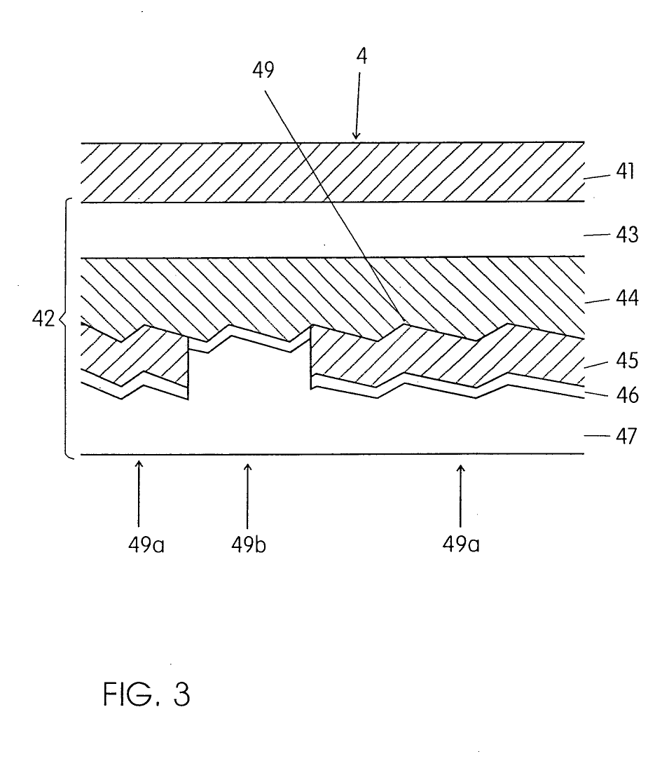

FIG. 3 shows a sectional view of a second embodiment of a multi-layer film according to the invention,

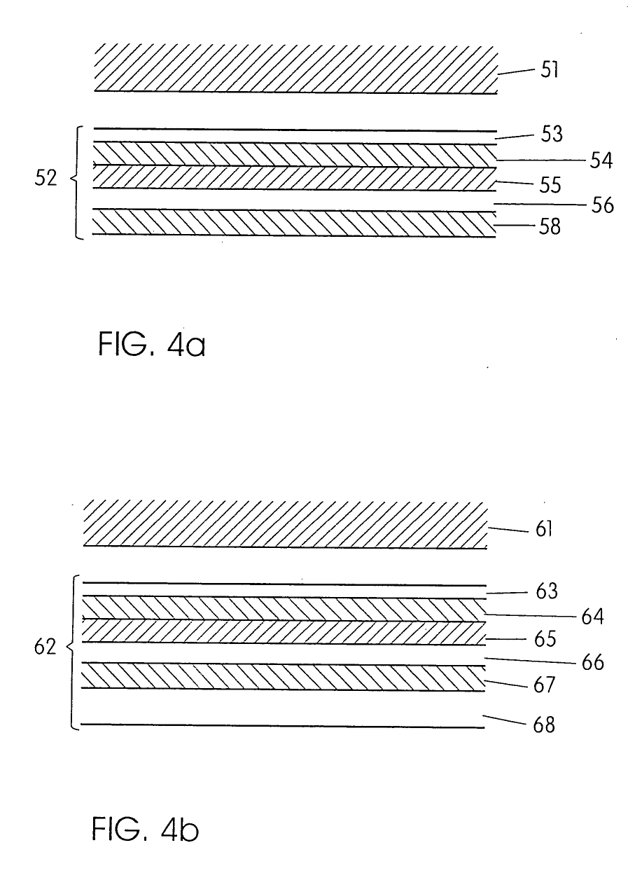

FIG. 4a shows a view illustrating the structure in principle of a multi-layer film according to the invention for a further embodiment of the invention,

FIG. 4b shows a view illustrating the structure in principle of a multi-layer film according to the invention for a further embodiment of the invention, and

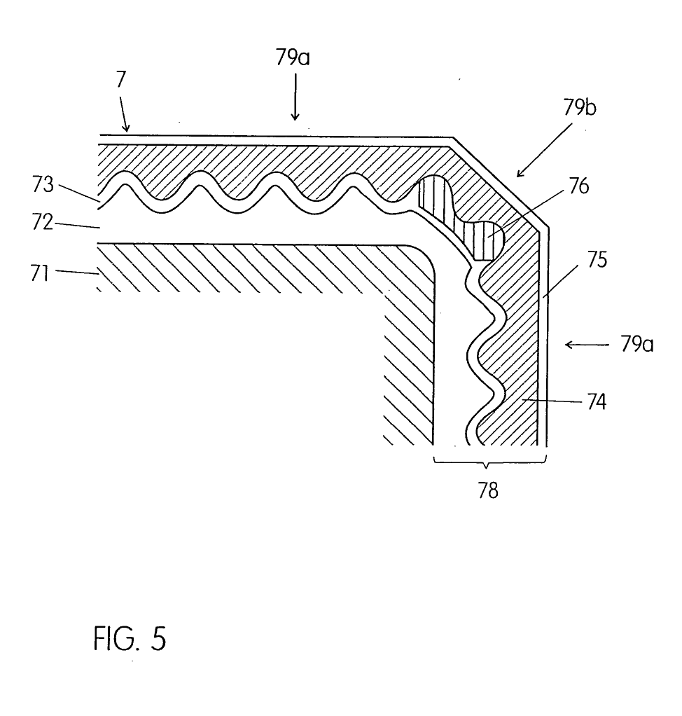

FIG. 5 shows a view of a part of a decorated article according to the invention in accordance with a further embodiment of the invention.

FIG. 1a shows a part of a decorated article 1. The decorated article 1 is a mobile telephone housing and/or a mobile telephone window. It will be appreciated that it is also possible for the decorated article 1 to involve a housing portion of a different kind of configuration or also a flat article, for example a card.

The decorated article 1 has a base body 13 and a multi-layer film 12.

The multi-layer film 12 is an IMD-able multi-layer film. In production of the base body 13 by an injection molding process, the multi-layer film 12—as described above—is pressed against the injection molding mold by the hot plastic material, whereby the multi-layer film 12 adopts the surface shape of the base body 13 and is joined to the base body 13. In a second step or at the same time a cover body 11 is injected by means of an injection molding process onto the composite structure consisting of the base body 13 and the multi-layer film 12. In that case it is possible for the multi-layer film 12 to be already pre-shaped, placed in the center of a suitably shaped injection molding mold, and to have plastic injection molding material injected therebehind on both sides.

In that respect, the multi-layer film 12 however may also involve a deep-drawable multi-layer film. IMD-films and deep-drawable films are both put into a three-dimensional configuration by pressure and heat. In the case of an IMD-film that is achieved by injecting plastic material therebehind, the injected material pressing the film into the three-dimensional configuration. In the case of deep-drawable films the film is firstly applied to a planar body which is then put into the desired three-dimensional shape by deep drawing. In this case also the film is put into a three-dimensional shape, corresponding to the shape of the deep drawing mold, by pressure and heat.

FIG. 1b shows an alternative structure of a decorated article. Thus FIG. 1b shows a part of a decorated article 2 having a multi-layer film 21 and a base body 22. The multi-layer film 21 also involves an IMD-able multi-layer film. That stamping film is introduced into an injection molding mold and liquid plastic injection molding material is injected therebehind, thereby producing the decorated article 2 comprising the base body 22 which is formed by the hardened injection molding material and the multi-layer film 21 which is joined thereto and which is formed by the IMD-able film which is shaped by the injection molding procedure.

It is also possible for the multi-layer films 12 and 21 to be joined to a preshaped base body by being pressed thereonto. If that procedure is selected, it is also possible to use stamping films which are not IMD-able. However in this case also the use of IMD-able stamping films is also to be recommended as otherwise distortion or folding is to be reckoned on, in the region of the curvatures 19 and 29.

The multi-layer films 12 and 21 have a transparent structure layer which has a spatial structure producing an optically perceptible effect, and a reflection layer arranged between the surface of the base body 13 and 22 respectively and the structure layer. In this respect the optical effect of the spatial structure is extinguished by means of an intermediate layer which is arranged between the structure layer and the reflection layer and which is formed in a pattern configuration and/or by means of demetalization of the reflection layer.

Structure layer configurations of the multi-layer films 12 and 21, which are possible in principle, will now be described with reference to FIGS. 2, 3, 4a and 4b.

FIG. 2 shows the multi-layer film 3 which is an IMD-able multi-layer film. The multi-layer film 3 has a carrier 31 and a decorative element 32. The carrier 31 comprises a PET material and is removed after application of the decorative element to the base body of the decorated article. In this case the carrier 31 involves a layer thickness of the order of magnitude of between 4.5 and 75 μm, preferably being 23 μm.

The decorative element 32 has a release layer 33, a protective lacquer layer 34, a structure layer 35 having a spatial structure 39, an intermediate layer 36, a reflection layer 37 and an adhesive layer 38. The decorative element 32 also has regions 39a and 39b with different properties.

The release layer 33 serves to release the decorative element 32 from the carrier 31. The release layer 33 comprises for example a wax material. It involves a layer thickness of the order of magnitude of between 0.001 and 0.1 μm.

The protective lacquer layer 34 is of a layer thickness which is of the order of magnitude in the region of between 1 and 20 μm. The protective lacquer layer 34 is preferably a thermoplastic lacquer layer having a high resistance to abrasion. In addition the protective lacquer layer can involve a cold-cross-linked, transparent cover lacquer. The protective lacquer layer 34 comprises for example PVC, acrylate, EVA, polyvinylester, PVB, polyester resin, ketone resin, formaldehyde resin, colophony resin, polyurethane resin or the like.

The structure layer 35 comprises a thermoplastic replication lacquer consisting of a thermoplastic material. Acrylates and chlorinated polymers and in particular also the materials disclosed in relation to the protective lacquer layer 34 are considered as materials for the structure layer 35.

The spatial structure 39 is embossed into the surface of the structure layer 35, which is oriented in the direction of the reflection layer 37. The spatial structure 39 has a roughness depth of the order of magnitude of between 0.8 and 10 μm and thus represents a structure which does not have an optical-diffraction effect. Such a structure produces for example the impression of a “brush effect”.

It is however also possible for the structure 39 to be a diffractive structure. For example holograms are produced by diffraction effects, by such a diffractive structure. It is further possible for the structure 39 to have an matt structure having scattering properties.

The layer 37 comprises a highly refractive material and has a layer thickness of the order of magnitude of 100 Å. The layer 37 can be formed by a metal oxide and/or by a metal sulfide. This can also involve zinc sulfides, titanium oxide, silicon oxide or the like. The layer 37 is preferably formed by a metal layer having reflective properties. For example chromium, aluminum, copper, silver, gold or similar metals but also alloys of two or more of those metals can be used as materials for that purpose. In addition, reflective plastic materials or polymers can also be used as the material for the layer 37. In that respect it is possible to use compounds similar to “Liquid Crystals” (for example “Helicone” from Wacker-Chemie; “Helicone” is a Wacker-Chemie trademark).

The use of a metal layer as the layer 37 has the advantage that such a metal layer has a high level of bending and stretching capability and is thus particularly suitable for the IMD area of use.

The intermediate layer 36 comprises a transparent extinguishing lacquer. In that respect the materials used for the extinguishing lacquer can be the same as those which are also used for the structure layer 35. The extinguishing lacquer thus preferably comprises a thermoplastic material.

It is advantageous in that respect to use for the intermediate layer 36 a material which has substantially identical optical properties to the material used for the structure layer 35. In particular the refractive indices of the two materials used should be substantially the same. This provides that no or almost no reflection phenomena occur at the transition between the structure layer 35 and the intermediate layer 36 and thus that transition is negligible from an optical point of view.

The thickness of the structure layer 35 and of the intermediate layer 36 is in each case of the order of magnitude in a range of between 1 and 10 μm.

The adhesive layer 38 comprises a conventional adhesive which is activatable by heat, pressure or radiation. The adhesive layer 38 is of a layer thickness which of the order of magnitude is in a range of between 1 and 10 μm. It is also possible to forego the adhesive layer 38 or to apply a plurality of adhesive layers to the reflection layer 37.

The procedure involved in production of the multi-layer film 3 is as follows:

The release layer 33, the protective lacquer layer 34 and the structure layer 35 are successively applied to the carrier 3 over the full surface area by means of a printing process. Partial application of those layers is also possible. The spatial structures 39 are then embossed into the structure layer 35 by means of an embossing tool. In that case the structure 39 is preferably embossed onto the structure layer 35 over the full area thereof. For example one or more embossing rollers can be used as the embossing tools.

Taking the “base film” produced in that way, the intermediate layer 36 is now partially applied thereto by printing in a pattern configuration. That printing operation can be effected for example by means of a suitably configured intaglio printing roller. The result of that pattern-shaped printing operation is shown by way of example in FIG. 2: the intermediate layer 36 has been applied by printing in the regions 39a and the intermediate layer 36 is absent in the region 39b.

It is also possible for the intermediate layer 36 to be applied by printing to the structure layer 35 over the full surface area. Then it is partially removed by means of a washing and/or etching operation (positive or negative etching) or by means of ablation (laser ablation).

The reflection layer 37 is then applied, preferably by vapor deposition or cathode sputtering.

It is also possible in that case to forego the release layer 33 and the protective lacquer layer 34.

If the multi-layer film 3 is used for decoration of the article illustrated in FIG. 1c, it is advantageous to forego the protective lacquer layer 34. In that case the function of the protective lacquer layer 34 is performed by the cover body. Thus FIG. 1c shows such a multi-layer film 24 which is applied in that way to the inside of a cover body 23 (“first or second surface decoration”).

It is further possible to insert one or more decorative color lacquer layers between the above-mentioned layers 34 through 37. A further option involves coloring the protective lacquer layer 34, the structure layer 35 and/or the extinguishing lacquer layer 36.

In addition it is also possible for the layers 35, 36 and 37 to be applied as described above and then partially removed by washing or etching. It is also possible for an etch resist to be partially applied to the layers 35, 36 and 37 and for layers then to be partially removed by washing or etching.

The above-described film structure provides the following optical effects:

In the region 39b there is the impression of a reflective element which is superimposed by the optical effect produced by the structure 39. Thus in the region 39b the viewer perceives a hologram or a structured, for example brushed, metal surface. The structure 39 is leveled by the intermediate layer 36 in the regions 39a. In that way the optical effect produced by the spatial structure 39 is extinguished by the intermediate layer 36. Thus in the regions 39a the viewer perceives a reflecting decorative element which is lacking the optical effect produced by the structure 39.

It is further possible for the reflection layer 37 or the reflection layer 37 and the extinguishing lacquer layer 36 to be partially removed and thus the arrangement partially produces the impression of a transparent element which is superimposed by the optical effect produced by the structure 39.

FIG. 3 shows a multi-layer film 4 having a carrier 41 and a decorative element 42. The carrier 41 is of a configuration like the carrier 31 shown in FIG. 2. The decorative element 42 has a protective lacquer layer 43, a structure layer 44, an intermediate layer 45, a reflection layer 46 and an adhesive layer 47.

The layers 44, 46 and 47 are of a configuration like the layers 35, 37 and 38 shown in FIG. 2.

The intermediate layer 45 comprises one or more extinguishing lacquer layers of an opaque material. As shown in FIG. 3 the intermediate layer 45 does not level the structure 49 but is of a substantially constant layer thickness.

That effect can also be achieved for example by a procedure whereby it is only after application of the reflection layer 46 that the structure 49 is embossed into the film body which has been constructed by then. Substantially the same materials as are used for the intermediate layer 36 can be employed for the intermediate layer 45. In contrast to the intermediate layer 36 however the intermediate layer 45 is not transparent but opaque. The reflection layer 46 is thus covered by the intermediate layer 45 in such a way that reflection phenomena no longer take place at the reflection layer 46. This provides that the optical effect produced by the structure 49 is not shown off in the regions 49a.

Accordingly the arrangement produces the following impressions for the viewer in the regions 49a and 49b: in the region 49b the viewer perceives a reflective element which is formatively influenced by the optical effect produced by the structure 49. Thus, in that region he perceives for example a hologram or a brushed, metallic surface. In the regions 49a he perceives a smooth surface which is formatively influenced by the color of the opaque material used for the intermediate layer 45.

It is also possible for the intermediate layer 45 to be produced in a pattern configuration in different opaque colored regions. Accordingly, in the regions 49a the viewer sees a corresponding color configuration which is not superimposed by the optical effect produced by the structure 49.

Reference is now made to FIGS. 4a and 4b to discuss possible ways in which the optical effect of the spatial structure can be extinguished in a pattern form by means of demetalization of the reflection layer 37:

FIG. 4a shows a carrier 51 and a multi-layer film 52. The carrier 51 is of the same configuration as the carrier 31 shown in FIG. 2. The multi-layer film 52 has a protective lacquer layer 53, a structure layer 54, an intermediate layer 55, a reflection layer 56 and an adhesive layer 58. The layers 53, 54, 56 and 58 are of the same configuration as the layers 34, 35, 37 and 38 of FIG. 2.

The intermediate layer 55 is formed by a masking lacquer which is applied by printing to the structure layer 54 in pattern form. The masking lacquer used can be for example a water-soluble lacquer (see the materials for the layer 34).

After the masking lacquer has been applied by printing, the reflection layer 56 is applied. That is effected for example by means of vapor deposition of a thin metal layer or by means of cathode sputtering. In a next step, the masking lacquer is removed by a washing operation and thus the reflection layer over the masking lacquer is also removed. The adhesive layer 58 is then applied. In that case, the adhesive employed is preferably an adhesive which has substantially the same optical properties (in particular refractive index) as the structure layer. In that fashion, no reflection phenomena occur at the transition between the structure layer and the adhesive layer in the regions in which the reflection layer has been removed by means of the masking lacquer layer 37. Further possible options provide opaquely coloring the adhesive layer 58 or applying the multi-layer film 52 to an opaque base body.

FIG. 4b shows a carrier 61 and a multi-layer film 62. The carrier 61 is of a configuration like the carrier 31 shown in FIG. 2. The multi-layer film 62 has a protective lacquer layer 63, a structure layer 64, an extinguishing lacquer layer 65, a reflection layer 66, an etching resist lacquer layer 67 and an adhesive layer 68. The layers 63, 64, 65, 66 and 68 are like the layers 34, 35, 36, 37 and 38 of FIG. 2.

The etching resist lacquer layer 67 is of a thickness which is of the order of magnitude in the range of between 1 and 10 μm, preferably in the range of between 1 and 2 μm. The etching resist lacquer layer 67 is applied to the reflection layer 66 by printing in a pattern configuration. Then, the surface regions of the reflection layer 66, which are not protected by the etching resist lacquer layer 67, are demetalized by means of a lye or an acid. In that way, as described with reference to FIG. 4a the optical effect produced by the structure of the structure layer 64 is partially extinguished in the regions in which the reflection layer 66 has been removed by means of the demetalization process.

It is also possible for the reflection layer 66 to be removed in a pattern configuration by positive etching (applying an etching agent by printing) or by an ablation process.

Reference will now be made to FIG. 5 to clearly show the regions of the structure layer in which now the optical effect of the spatial structure is preferably to be extinguished.

FIG. 5 shows a decorated article 7 having a base body 71 and a multi-layer film 78 applied to the base body 71. The multi-layer film 78 comprises a protective lacquer layer 75, a structure layer 74, an intermediate layer 76, a reflection layer 73 and an adhesive layer 72. The layers 75, 74, 76, 73 and 72 are of configurations like the layers 34, 35, 36, 37 and 38 of FIG. 2.

The optical effect of the spatial structure is now extinguished in regions in which the curvature of the structure layer exceeds a given limit value. Thus FIG. 5 shows a region 79b of the decorated article 7, in which the base body 71 is shaped to form a corner with a really tight edge radius.

In the embodiment of FIG. 5, the structure layer 74 is formed from a flexible thermoplastic material. As can be seen from FIG. 5, upon being applied to the surface of the base body 71, in the region 79b, the structure layer 74 is greatly stretched by virtue of the tight edge radius of the base body 71, whereby the spatial structure of the structure layer 74 is also deformed at the same time in that region. The smaller the edge radius, the correspondingly greater is the extent of such stretching and thus the change in the structure layer 74.

In order now to prevent the optical appearance of the article 7 being adversely impaired by that effect, the intermediate layer 76 consisting of an extinguishing lacquer is introduced in the region 79b between the structure layer 74 and the reflection layer 73. The optical effect which is produced by the structure layer 74 and which is falsified in that region is extinguished by the intermediate layer 76 so that such falsification of the optical structure is not apparent but rather there are no further structuring effects.

The limit value at which, as shown in FIG. 5, the intermediate layer 76 is to be introduced between the structure layer 74 and the reflection layer 73, is preferably determined by the radius of curvature of the base body at which there are visible changes in the optical effect of the spatial structure due to bending of the structure. That radius depends on the one hand on the size and nature of the spatial structure, on the film thickness of the multi-layer film 78 and the materials used in the film layers. In that respect the limit value can be easily determined by experimental investigation in which the multi-layer film 78 is bent with a decreasing radius.

In this case, the effect illustrated with reference to FIG. 5, and also in relation to a similar film structure as that shown in FIGS. 1 through 5, can be achieved by the following measures:

In contrast to FIG. 5, the material used for example for the structure layer 84 may be not a flexible thermoplastic material but a flexurally stable plastic material. That material has the advantage that it deforms only to a slight degree and thus the surface structure is substantially maintained when flexing is involved. In addition, desired-fracture locations are provided in the structure layer so that the structure layer 84 breaks up into pre-defined fracture portions when the multi-layer film is bent to a relatively great degree. If in a region the base body forms an edge with a tight radius of curvature, the result of this is that the structure layer which is disposed thereover is also severely curved in that region and thus the structure layer breaks up into pre-defined fracture portions.

Desired-fracture locations of that kind in the structure layer can be achieved on the one hand by the configuration of the spatial structure which is embossed into the structure layer. Thus it is possible here to emboss grooves into the structure layer at given spacings, the grooves acting as desired-fracture locations. Grooves of that kind can also be produced by laser ablation or by a photochemical ablation procedure. There is also the possibility of producing the structure layer from a replication lacquer in which nanoparticles or microscopically large particles are introduced, which result in pre-defined embrittlement of the structure layer and define desired-fracture locations. Thus it is possible for example to introduce nano-SO₂-particles or microscopically large Cu-particles into the replication lacquer. The use of metal particles or metal oxide particles has proven to be advantageous in that respect.

In that connection such particles can additionally contribute to coloration of the structure layer.

In this respect the desired-fracture locations can be arranged in such a way that the optical effect produced by the structure is not adversely affected by the structure layer breaking in the region of the desired-fracture locations. For that purpose, the desired-fracture locations are matched to the spatial surface structure in such a way that interrelated items of image information remain in a fracture portion. Thus for example desired-fracture locations are provided at transitions between regions of the spatial structure, which are associated with different image pixels.

It is also possible for the desired-fracture locations to be arranged in such a way that the optical effect is no longer produced in regions in which the structure layer is broken up. That can be achieved for example by providing a high number of desired-fracture locations which involve random distribution and which prevent the production of an optical effect by the spatial structure. That can be implemented for example by severe embrittlement of the structure layer by admixing nano-particles.

In addition it is also possible for the reflection layer to have desired-fracture locations so that the reflection layer breaks up in a defined manner in regions in which the curvature of the reflection layer exceeds a limit value, whereby the optical effect produced by the structure is extinguished in that region. That can be achieved if the interrelated reflection layer has a plurality of randomly distributed desired-fracture locations so that, when a given radius of curvature is exceeded, the reflection layer breaks up into a large number of statistically distributed, very small reflection surfaces. That provides that adequately directed reflection of the incident light is no longer guaranteed in the curvature regions so that the optical effects produced by the optically effective spatial structure can no longer be recognized by the viewer. By way of example in that respect diffractive effects are so very greatly attenuated by the specifically targeted, fine-grain fracture of the reflection layer and the scatter effects which occur as a result, that those effects are no longer visible or are scarcely visible to the human viewer.

A reflection layer which is provided with desired-fracture locations in that way is achieved for example by virtue of differing mechanical characteristics in respect of the reflection layer and previous and/or subsequent layers. The fracture and/or stretch characteristics of the reflection layer in comparison with the previous and/or subsequent layer or layers are so selected that fractures occur in the relatively brittle reflection layer, as from a given bending radius which is pre-defined by the mechanical properties. In that respect it is also possible to provide a further intermediate layer which serves to afford a pre-defined difference of that kind in the fracture and stretch characteristics.

In addition the measures already disclosed in relation to the structure layer for providing the desired-fracture locations (mechanically pre-defined weakening, admixing of particles) can also be applied to the reflection layer or the multi-layer body forming the reflection layer.

It is further advantageous to provide a thermally insulating layer between the structure layer and the reflection layer, the thermally insulating layer also having a higher refractive index than the structure layer. For example it is possible for that purpose to use MₓO_{y}-layers (MₓO_{y}:x;y[0.1 through 8]; M: element). Such layers provide on the one hand an increase in sharpness in depth and on the other hand better thermal protection for the structure layer.

1. A multi-layer film for the production of a decorated article which has a base body decorated with the multi-layer film and having curved surface regions, wherein the multi-layer film is an IMD-film or a deep-drawable film which is deformable in production of the decorated article in accordance with the curvature of the base body of the decorated article, wherein
the IMD-film or deep-drawable film has a transparent structure layer which has a spatial structure producing an optically perceptible effect, and a reflection layer arranged beneath the structure layer in the viewing direction.

2. A multi-layer film as set forth in claim 1, wherein the optical effect of the spatial structure is extinguished in a pattern configuration by means of an intermediate layer which is shaped in pattern form and which is arranged between the structure layer and the reflection layer and/or by means of removal in a pattern configuration, in particular demetalization, of the reflection layer in regions in which the curvature of the base body to be decorated with the multi-layer film and thus a curvature of the spatial structure on the decorated article exceeds a limit value, wherein
a) the limit value is either a radius of curvature at which changes in the optical effect of the spatial structure, which are visible to a viewer of the decorated article, occur due to bending of the structure layer, or
b) the limit value is a radius of curvature at which breaks occur in the structure layer.

3. A multi-layer film as set forth in claim 2, wherein the intermediate layer comprises one or more extinguishing lacquer layers which comprise a transparent material and which level the structure of the structure layer in a pattern configuration.

4. A multi-layer film as set forth in claim 2, wherein the intermediate layer comprises one or more extinguishing lacquer layers comprising an opaque material.

5. A multi-layer film as set forth in claim 2, wherein the intermediate layer has a masking layer which is partially removed with the post-applied part of the reflection layer.

6. A multi-layer film as set forth in claim 2, wherein the intermediate layer comprises a thermoplastic material.

7. A multi-layer film as set forth in claim 2, wherein the flexibility of the intermediate layer is different from that of the structure layer.

8. A multi-layer film as set forth in claim 2, wherein the intermediate layer and/or the structure layer is colored.

9. A multi-layer film as set forth in claim 1, wherein the structure layer has desired-fracture locations so that the structure layer breaks up in a defined fashion in regions in which a curvature of the structure layer in a curved surface region exceeds a limit value.

10. A multi-layer film as set forth in claim 9, wherein the desired-fracture locations are so arranged that the optical effect produced by the structure is not impaired by the fracture of the structure layer in the region of the desired-fracture locations.

11. A multi-layer film as set forth in claim 9, wherein the desired-fracture locations are so arranged that the optical effect produced by the structure is no longer produced in regions in which the structure layer has broken up.

12. A multi-layer film as set forth in claim 1, wherein the reflection layer has desired-fracture locations so that the reflection layer breaks up in a defined fashion in regions in which a curvature of the structure layer in curved surface regions exceeds a limit value, thereby extinguishing the optical effect produced by the structure in said regions.

13. A multi-layer film as set forth in claim 1, wherein a further layer with a higher refractive index than the structure layer is arranged between the structure layer and the reflection layer.

14. A multi-layer film as set forth in claim 13, wherein the further layer comprises a material having thermally insulating properties.

15. A multi-layer film as set forth in claim 13, wherein the reflection layer is removed in a window-shaped region.

16. A multi-layer film as set forth in claim 1, wherein the structure layer ( comprises a thermoplastic material into which the spatial structure is embossed.

17. A multi-layer film as set forth in claim 1, wherein the structure has a visible structure which does not have an optical-diffraction effect with a roughness depth of the order of magnitude of between 0.8 and 10 μm.

18. A multi-layer film as set forth in claim 1, wherein the structure has a diffractive structure with an optical-diffraction effect.

19. A multi-layer film as set forth in claim 1, wherein the reflection layer is a metal layer, a layer comprising a metal oxide or a metal sulfide, or a layer comprising a reflective plastic material.

20. A decorated article, in particular a mobile telephone housing or a mobile telephone window, which has a base body which has curved surface regions and at least one decorative element arranged in the region of one or more curvatures of the surface of the base body, characterized in that the decorative element is formed by a multi-layer film as set forth in claim 1, which is deformed in production of the base body in accordance with the one or more curvatures.

21. A decorated article as set forth in claim 20, wherein the optical effect of the spatial structure is extinguished in a pattern configuration by means of an intermediate layer which is shaped in pattern form and which is arranged between the structure layer and the reflection layer and/or by means of removal in a pattern configuration, in particular demetalization, of the reflection layer in regions in which the curvature of the structure exceeds a limit value.

22. A decorated article as set forth in claim 21, wherein the limit value is the radius of curvature at which changes in the optical effect of the spatial structure, which are visible to a viewer, occur due to the bending of the structure layer.

23. A decorated article as set forth in claim 22, wherein the limit value is a radius of curvature at which breaks occur in the structure layer.

24. A decorated article as set forth in claim 21, wherein structure layer has desired-fracture locations so that the structure layer breaks up in a defined fashion in regions in which the curvature of the structure layer exceeds a limit value.

25. A decorated article as set forth in claim 24, wherein the desired-fracture locations are so arranged that the optical effect produced by the structure is not impaired by the fracture of the structure layer in the region of the desired-fracture locations.

26. A decorated article as set forth in claim 24, wherein the desired-fracture locations are so arranged that the optical effect produced by the structure is no longer produced in regions in which the structure layer has broken up.

27. A decorated article as set forth in claim 20, wherein the reflection layer has desired-fracture locations so that the reflection layer breaks up in a defined fashion in regions in which the curvature of the structure layer exceeds a limit value, thereby extinguishing the optical effect produced by the structure in said regions.

28. Use of a multi-layer film as set forth in claim 1, wherein in an in-mold injection molding process or a deep-drawing process for the decoration of a base body having curved surface regions at least in the region of one or more curvatures of the surface of the base body.
